(19) United States
(12) Patent Application Publication
(10) Pub. No.: US 2004/0059033 A1
(43) Pub. Date: Mar. 25, 2004

(54) Composition for anti-reflective coating and method for manufacturing semiconductor device

(75) Inventor: Minoru Toriumi, Yokohama (JP)

Correspondence Address: FOLEY AND LARDNER, SUITE 500, 3000 K STREET NW, WASHINGTON, DC, 20007, US

(73) Assignee: Semiconductor Leading Edge Technologies, Inc.

(21) Appl. No.: 10/676,082

(22) Filed: Oct. 2, 2003

Related U.S. Application Data
(62) Division of application No. 09/986,048, filed on Nov. 7, 2001.

(30) Foreign Application Priority Data
Feb. 8, 2001 (JP) 20001-032918

(51) Int. Cl. C08L 1/00

(52) U.S. Cl. 524/356; 524/544

(57) ABSTRACT

A composition for anti-reflective coatings comprising a polymer that contains fluorine and a solvent that dissolves the polymer is applied onto a semiconductor substrate to form an anti-reflective coating. Next, a resist film containing fluorine is formed on the anti-reflective coating. Then, the resist film is irradiated by exposure light to form resist patterns.

### BACKGROUND OF THE INVENTION

1. Field of the Invention

The present invention relates to lithography technique used in the manufacturing process of semiconductor devices, and specifically to the adhesion between an anti-reflective coating and a resist film.

2. Description of the Background Art

In the manufacturing process of semiconductor devices, lithography technique is used to form a resist pattern on a semiconductor substrate such as, for example, a silicon wafer.

Here, lithography technique will be described below.

First, a resist film (resist layer) is formed on a semiconductor substrate as a substrate to be processed. More specifically, there is formed an organic layer having the solubility to an alkaline solution of whose area irradiated by active beams such as ultraviolet rays changes.

Next, active beams, such as ultraviolet rays, far ultraviolet rays, excimer laser beams, X rays, and electron beams are selectively radiated onto the above-described resist film through a mask (reticle) on which a desired pattern has been formed.

Finally, the resist film is developed to form a resist pattern. In more detail, the resist film is developed using an alkaline solution to remove the area that has higher solubility to this alkaline solution (the exposed area in the case of a positive resist) leaving the area that has lower solubility. Thereby, a resist pattern is formed on the semiconductor substrate.

Next, the area on which the resist pattern has not been formed, that is the exposed surface of the substrate or the film to be processed is subjected to etching.

Then, the resist pattern is removed by plasma ashing and a chemical solution or the like. Thereby, device patterns required for various wirings, electrodes, and the like are formed.

The lithography technique presently used for mass production is photolithography technique using, for example, KrF or ArF excimer laser beams. By repeating patterning using the photolithography technique, a large number of semiconductor devices (semiconductor elements) are produced on a semiconductor substrate.

Also as the resists used in the photolithography technique include negative resists whose areas irradiated by active beams become insoluble in development, and positive resists whose areas irradiated by active beams are dissolved and removed in development, which are suitably selected according to the purpose of use.

However, in patterning using the photolithography technique, it has been known that the multiple interference of exposure light (active beams) occurs in the resist film, and the width of resist patterns varies concurrent to the variation of the thickness of the resist film.

This multiple interference is caused by the interference of exposure light incident to the resist film with reflected light from the substrate, which makes the exposure intensity uneven in the thickness direction of the resist film. Furthermore, this multiple interference affects the width of the resist pattern obtained after development, resulting in the lowered dimensional accuracy of the resist pattern.

This is particularly significant when a fine resist pattern is formed on a substrate that has difference in level. More specifically, when a resist is applied onto a substrate that has difference in level, the thickness of the resist film becomes uneven due to the difference in level, and the multiple interference of the exposure light occurs. This lowers the dimensional accuracy of the resist pattern, and the pattern with high resolution cannot be formed.

Therefore, there has been demand for the development of techniques for forming fine patterns of high dimensional accuracy even on a substrate that has difference in level.

As a means for reducing the interference of light, U.S. Pat. No. 4,910,122 proposes a method for forming an anti-reflective coating (ARC) on a substrate to be processed.

The anti-reflective coating is a uniform thin film that is inserted underneath the photoresist film as a photosensitive layer, and contains a light absorbing dye. The anti-reflective coating absorbs the light reflected form the substrate, and facilitates fine photosensitive film patterns (resist patterns) to be formed at high dimensional accuracy. Many types of anti-reflective coatings are available in the market.

In resent years, the wavelength of light used in the photolithography technique has become shorter concurrent with reduction in the size of device patterns. Specifically, the lithography technique using F₂ excimer laser of a wavelength of 157 nm as the light source has been examined actively.

However, since ordinary substances absorb much light having vacuum ultraviolet wavelengths as short as 157 nm, there has been a problem that conventional photoresist materials cannot be used.

In order to solve this problem, a photoresist composition that contains a fluorocarbon resin having high transparency to the light source of short wavelengths (hereafter called “fluorocarbon-resin-based resist”) is proposed.

However, the fluorocarbon-resin-based resist has a problem of poor adhesion to ordinary anti-reflective coatings. Here, the ordinary anti-reflective coatings means phenolic-resin-based anti-reflective coatings or the like.

Therefore, there is a problem that the fluorocarbon-resin-based resist cannot be applied onto the anti-reflective coating.

Also there is another problem that the fluorocarbon-resin-based resist is separated from the anti-reflective coating during development.

Therefore, the fluorocarbon-resin-based resist cannot be formed on the anti-reflective coating with good adhesion. Thus, there is a problem that the fluorocarbon-resin-based resist cannot be used in the lithography technique using F₂ excimer laser as the light source.

### SUMMARY OF THE INVENTION

The present invention has been conceived to solve the previously-mentioned problems and a general object of the present invention is to provide a novel and useful composition for forming an anti-reflective coating and to provide a novel and useful method for manufacturing a semiconductor device.

A more specific object of the present invention is to provide a composition for anti-reflective coatings that excels in adhesion to fluorocarbon-resin-based resists and is to form fine resist patterns by applying a fluorocarbon-resin-based resist to the photolithography technique.

The above object of the present invention is attained by a following method of manufacturing a semiconductor device and a following semiconductor device.

According to one aspect of the present invention, the composition for forming an anti-reflective coating on a semiconductor substrate, comprises: a polymer containing fluorine; and a solvent for dissolving the polymer.

According to another aspect of the present invention, the method for manufacturing a semiconductor device, comprises: an anti-reflective coating forming step for forming an anti-reflective coating by coating the composition for an anti-reflective coating according to one aspect of the present invention on a semiconductor substrate; a resist film forming step for forming a resist film containing fluorine on the anti-reflective coating formed in the anti-reflective coating forming step; and an exposure step for radiating exposure light onto the resist film formed in the resist film forming step.

Other objects and further features of the present invention will be apparent from the following detailed description when read in conjunction with the accompanying drawings.

### BRIEF DESCRIPTION OF THE DRAWINGS

FIGS. 1A to 1C are cross-sectional views for describing a method for manufacturing a semiconductor device according to a first embodiment of the present invention; and

FIGS. 2A to 2E are cross-sectional views for describing a method for manufacturing a semiconductor device according to a second embodiment of the present invention.

### DETAILED DESCRIPTION OF THE PREFERRED EMBODIMENTS

In the following, principles and embodiments of the present invention will be described with reference to the accompanying drawings. The members and steps that are common to some of the drawings are given the same reference numerals and redundant descriptions therefore may be omitted.

First Embodiment

A composition for anti-reflective coatings according to a first embodiment of the present invention will be described below.

The composition for anti-reflective coatings according to the first embodiment comprises a polymer that contains fluorine, and a solvent that dissolves the polymer.

First, the polymer that contains fluorine will be described.

The polymer contains at least one of fluorocarbon resins, polyimides containing fluorine, acrylic polymers containing fluorine, and polymers containing fluorine and having an alicyclic structure. The methods for manufacturing the polymer are methods known to public or known to those skilled in the art.

Here, the fluorocarbon resins are formed by homo-polymerizing or co-polymerizing monomers that contain fluorine.

The monomers that contain fluorine include fluoroolefines, fluorovinylether, and the like. Specifically, preferable monomers are tetrafluoroethylene, trifluoroethylene, hexafluoropropylene, perfluoroalkyl vinylethers (e.g., perfluoromethyl vinylether and perfluoropropylvinylether), and perfluorovinylether. Furthermore, perfluorovinylether having functional groups such as a carboxylic group (—COOH group) and a sulfonic group (—SO₂OH group) are also preferable monomers.

In addition, the examples of preferable monomers include vinylidene fluoride, vinyl fluoride, and chlorofluoroolefines such as chlorotrifluoroethylene.

Such monomers are polymerized alone, or in combination. Furthermore, the monomers may be copolymerized with other monomers unless the nature of such monomers is lost. Here, the other monomers to be copolymerized are not limited to specific monomers as long as the monomers are susceptible to radical polymerization, and include monomers that contain fluorine as described above, or hydrocarbon-based monomers. Furthermore, the polymer that contains fluorine and has an alicyclic structure can be formed by polymerizing one of these other monomers alone, or by radical-copolymerizing with a monomer that can introduce a specific ring structure. Also, two or more other monomers may be radical-copolymerized in combination.

The polymer contains preferably 10% by weight or more fluorine atoms, more preferably 40% by weight or more fluorine atoms. If the fluorine content of the polymer is too low, the unique characteristics of the fluorine atom is hardly exerted. The unique characteristics used herein are the characteristics of fluorine that affect the adhesion of the anti-reflective coating and the resist film, which will be described later.

The fluorocarbon resin may be a mixture with other resins. The other resins include, for example, novolak-based resins, polyvinylphenol-based resins, the mixture of these resins, or copolymers that contain at least one of these resins.

The fluorocarbon resin may be adequately cross-linked. Thereby, the reaction between the anti-reflective coating and the resist composition can be prevented when the resist composition is applied onto the anti-reflective coating, and the formation of a mixing layer at the interface between the anti-reflective coating and the resist composition can be prevented. Also, cross-linking may control etching resistance depending on process conditions.

The method for cross-linking may be the one normally practiced. For example, a method by copolymerizing monomers having cross-linking sites, a method by adding a cross-linking agent, or a method using radioactive rays. Polymers other than fluorocarbon resins, namely polyimides containing fluorine, acrylic copolymers containing fluorine, or polymers containing fluorine and having an alicyclic structure, may also be cross-linked.

Next, the solvent will be described.

The solvent is adopted to dissolve the polymer, and include at least one of alcohols, aromatic hydrocarbons, ketones, esters, chlorofluorocarbons, and super pure water.

Next, a method for manufacturing a semiconductor device comprising the process for forming an anti-reflective coating using the above-described composition for anti-reflective coatings will be described.

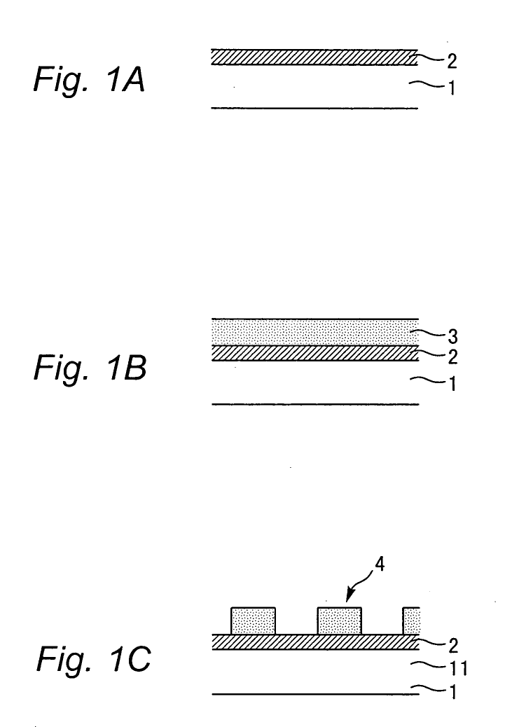

FIGS. 1A to 1C are cross-sectional views for describing a method for manufacturing a semiconductor device according to a first embodiment of the present invention.

First, as shown in FIG. 1A, the above-described composition for anti-reflective coatings is spin-coated on a semiconductor substrate 1. Before applying the composition for anti-reflective coatings, the surface of the semiconductor substrate may be treated with HMDS (hexamethyldisilazane) (refer to a second embodiment for details).

Next, in order to remove the solvent contained in the composition for anti-reflective coatings, heat treatment (heat drying process) is performed. Thereby, an anti-reflective coating 2 is formed on a semiconductor substrate 1. The heat treatment is preferably performed within a temperature range between 100° C. and 250° C. for 30 seconds to 60 minutes.

It is preferable, from the point of view of functions (optical characteristics), that the thickness of the anti-reflective coating 2 after the heat treatment is 150 nm or less.

Although the heat treatment is performed in the air or in a nitrogen atmosphere, it may also be performed in an oxygen atmosphere. If the heat treatment is performed in the oxygen atmosphere, the anti-reflective coating is oxidized, and the index of refraction changes, whereby the index of refraction of the anti-reflective coating can be controlled.

Here, as is well known, it is preferable that the index of refraction of the anti-reflective coating is agreed with the index of refraction of the photoresist film that will be described later. However, it is not necessary to entirely agree the indices of refraction of the anti-reflective coating and the photoresist film as long as the reflectance R of the anti-reflective coating is 10% or less.

Also in order to agree the index of refraction of the anti-reflective coating with the index of refraction of an ordinary photoresist, it is preferable that the real part value of the complex index of refraction of the anti-reflective coating is within a range 1.0<n<3.0, and the imaginary part value is within a range 0.4<k<1.3.

The index of refraction of the anti-reflective coating can be controlled by any well-known methods. Such methods include, for example, a method for lowering the index of refraction by introducing fluorine atoms in the composition for anti-reflective coatings, or a method for elevating the index of refraction by introducing a colorant that absorbs light of desired wavelengths.

Next, as shown in FIG. 1B, a photoresist film that contains fluorine (hereafter called “a fluorocarbon-resin-based resis”t) 3 is formed on the anti-reflective coating 2.

Then, the resist film 3 is exposed to an F₂ excimer laser as a light source, and is developed. Thereby, a resist pattern 4 as shown in FIG. 1C is formed.

As described above, the composition for anti-reflective coatings according to the first embodiment comprises a polymer that contains fluorine, and a solvent that dissolve the polymer.

The anti-reflective coating 2 formed by using this composition for anti-reflective coatings has a high adhesiveness to the fluorocarbon-resin-based resist 3. Therefore, the occurrence of resist pattern separation or resist pattern falling can be prevented at the interface with the anti-reflective coating 2.

Therefore, since the fluorocarbon-resin-based resist, from which high resolution can be expected, can be applied to the photolithography technique, a fine resist pattern 4 can be formed.

Although a fluorocarbon-resin-based resist is used as the photoresist film 3 in the first embodiment, the resist may be selected optionally from generally used positive or negative types of photoresist, and the optimal resist can be selected depending on the dimension, required accuracy, and the characteristics of exposing system.

Also in the first embodiment, although the anti-reflective coating 2 is formed directly on a semiconductor substrate 1, the anti-reflective coating is normally formed on a film to be processed, such as an insulating film or a metal film, formed on the semiconductor substrate. Therefore, fine device patterns can be formed by etching the insulating film or the metal film using fine resist patterns 4 as masks.

Also, the present invention is not limited to the application to semiconductor substrates such as a silicon substrate, but also can be applied to insulating substrates such as a quartz substrate and a ceramic substrate. (This is also applied to a second embodiment through a sixth embodiment, which will be described later.)

Second Embodiment

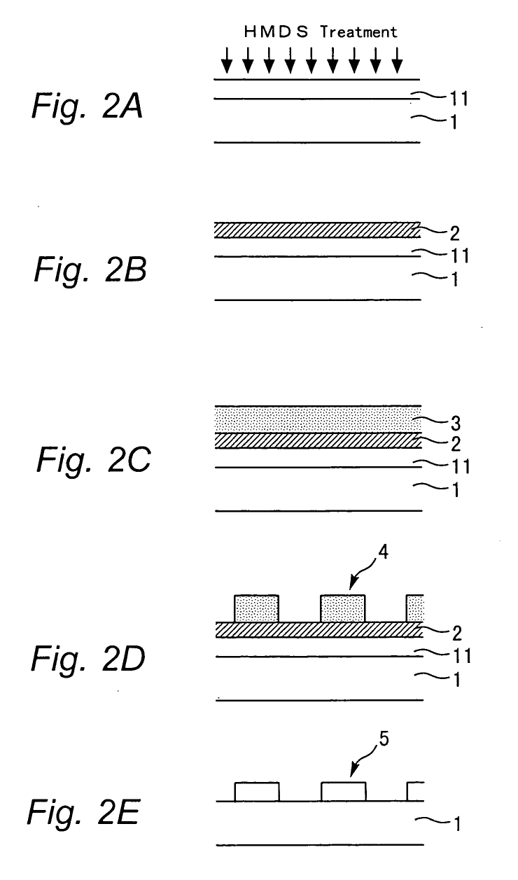

FIGS. 2A to 2E are cross-sectional views for describing a method for manufacturing a semiconductor device according to a second embodiment of the present invention. A method for manufacturing a semiconductor device according to a second embodiment will be described below referring to FIG. 2.

First, as shown in FIG. 2A, the surface of a film to be processed 11 formed on a semiconductor substrate 1 is treated with HMDS (hexamethyldisilazane) at a temperature of 110° C. for 60 seconds. The HMDS treatment is performed for improving adhesion between the film to be processed 11 on the semiconductor substrate 1 and the anti-reflective coating 2 (described later). More specifically, HMDS [chemical formula: (CH₃)₃SiNHSi(CH₃)₃] used as a adhesion enhancing agent is vaporized to coat the film to be processed 11 on the semiconductor substrate 1.

Next, the composition for anti-reflective coatings is spin-coated on the film to be processed 11 treated with HMDS. The composition for anti-reflective coatings used herein is a butyl acetate solution containing 1 g of the copolymer of tetrafluoroethylene and propylene as the polymer, and 10 g of butyl acetate as the solvent.

Next, the semiconductor substrate 1 is heat-treated at a temperature of 180° C. for 60 seconds. Thereby, as shown in FIG. 2B, an anti-reflective coating 2 of a thickness of 80 nm is formed on the film to be processed 11.

Next, a fluorine-containing resist composition (fluorocarbon-resin-based resist) containing, for example, tetrafluoroethylene is spin-coated on the anti-reflective coating 2.

Then, the semiconductor substrate 1 is heat-treated at a temperature of 120° C. for 60 seconds. Thereby, as shown in FIG. 2C, a resist film 3 of a thickness of 200 nm is formed.

Next, the resist film 3 is exposed to ultraviolet rays of a wavelength of 157 nm from F₂ excimer laser exposing system.

Then, the resist film 3 is developed using an alkaline developer. Thereby, as shown in FIG. 2D, fine resist patterns 4 are formed.

Next, the film to be processed 11 is subjected to dry etching using the resist patterns 4 as masks. Then, the resist pattern 4 is removed. Thereby, fine device patterns 5 are formed. In this dry etching, the anti-reflective coating 2 is first etched.

As described above, in the method for manufacturing a semiconductor device according to the second embodiment, the composition for anti-reflective coating comprising the polymer that contains fluorine is applied onto the film to be processed 11 formed on the semiconductor substrate 1 to form the anti-reflective coating 2. Then, the resist composition that contains fluorine is applied onto the anti-reflective coating 2 to form the resist film 3. Furthermore, exposure light is radiated on the resist film 3 to form the resist patterns 4.

According to the above-described manufacturing method, since both the anti-reflective coating 2 and the resist patterns 4 contain fluorine, excellent adhesiveness is obtained. Therefore, the separation and falling of resist patterns at the interface with the anti-reflective coating can be prevented.

Therefore, since a fluorocarbon-resin-based resist suitable for F₂ excimer laser can be applied to the photolithography technique, fine resist patterns 4 can be formed.

In addition, by etching using such fine resist patterns 4, fine device patterns 5 can be formed. That is, the size of device patterns of a semiconductor device can be reduced.

In the second embodiment, the resist film 3 is exposed to ultraviolet rays having a wavelength of 157 nm from F₂ excimer laser exposing system, but the same effect was obtained when the resist film was exposed to ultraviolet rays having a wavelength of 193 nm from ArF excimer laser exposing system. That is, the obtained fluorocarbon-resin-based resist patterns were fine patterns without separation or falling at the interface with the anti-reflective coating.

In the second embodiment, although the copolymer of tetrafluoroethylene and propylene is used as the fluorine-containing polymer in the composition for anti-reflective coatings, the second embodiment is not limited to this, but the polymer described in the first embodiment can also be used. (This is also applied to the following embodiments.)

The following experiments 1 and 2 were conducted to verify the effects in the second embodiment.

(Experiment 1)

First, the surface of a semiconductor substrate was subject to the above-described HMDS treatment.

Next, without forming an anti-reflective coating, the above-described fluorine-containing resist composition that contains tetrafluoroethylene was spin-coated on the semiconductor substrate.

In Experiment 1, however, the resist composition was repelled on the semiconductor substrate, and it was difficult to apply the resist composition evenly with spin coating. Therefore, fine resist patterns could not be formed using the fluorine-containing resist composition.

(Experiment 2)

After the HMDS treatment, an anti-reflective coating is formed using a phenolic-resin-based composition for anti-reflective coatings without containing fluorine in place of the composition for anti-reflective coatings used in the second embodiment.

Next, the fluorine-containing resist composition that contains tetrafluoroethylene used in the second embodiment is spin-coated on the anti-reflective coatings.

However, the resist composition is repelled on the anti-reflective coatings, and it is difficult to apply the resist composition evenly with spin coating.

Furthermore, although the process is continued to pattern exposure, the fine resist patterns obtained after developing separated and fell down at the interface with the anti-reflective coatings. Therefore, the fluorocarbon-resin-based photoresist could not be applied to the manufacture of semiconductor devices.

Third Embodiment

A method for manufacturing a semiconductor device according to a third embodiment is the same as the method for manufacturing a semiconductor device according to the above-described second embodiment, except for a composition for anti-reflective coatings, and a heat treatment performed after the application of the composition for anti-reflective coatings.

The description below will be focused on these differences, and the descriptions of items overlapping the items in the second embodiment will be omitted.

First, a composition for anti-reflective coatings according to the third embodiment will be described.

The composition for anti-reflective coatings according to the third embodiment is an water-based dispersion of a solid content of 10% by weight, comprising a fluorine-containing polymer consisting of a copolymer (ionic emulsifier) of tetrafluoroethylene, hexafluoropropylene, and vinylidene chloride, and a solvent consisting of super pure water.

Next, a method for manufacturing a semiconductor device using the above-described composition for anti-reflective coatings will be described.

First, the surface of a semiconductor substrate is treated with HMDS.

Next, the above-described water-based dispersion as a composition for anti-reflective coatings is spin-coated on the semiconductor substrate.

Then, the semiconductor substrate is subjected to heat treatment at a temperature of 150° C. for 30 minutes. Thereby, an anti-reflective coating of a thickness of 100 nm is formed on the semiconductor substrate.

Thereafter, resist patterns are formed in the same manner as in the second embodiment.

As described above, in the method for manufacturing a semiconductor device according to the third embodiment, the anti-reflective coating was formed through the use of the composition for anti-reflective coatings comprising polymer that contains fluorine, and fluorocarbon-resin-based resist patterns were formed on the anti-reflective coating.

According to this manufacturing method, the same effect as in the second embodiment can be obtained.

Furthermore, the dimensional variation, which was about ±50 nm when the composition for anti-reflective coatings according to the third embodiment is not used, could be reduced to about ±20 nm. That is, the resist patterns could be formed in high accuracy.

Fourth Embodiment

A method for manufacturing a semiconductor device according to a fourth embodiment is the same as the method for manufacturing a semiconductor device according to the above-described second embodiment, except for a composition for anti-reflective coatings, and a heat treatment performed after the application of the composition for anti-reflective coatings.

The description below will be focused on these differences, and the description of items overlapping the items in the second embodiment will be omitted.

First, a composition for anti-reflective coatings according to a fourth embodiment will be described.

The composition for anti-reflective coatings according to the fourth embodiment is a butyl acetate solution of a solid content of 5%, comprising a polymer of vinylidene chloride as a fluorine-containing polymer, and butyl acetate as a solvent.

Next, a method for manufacturing a semiconductor device using the above-described composition for anti-reflective coatings will be described.

First, the surface of a semiconductor substrate is treated with HMDS.

Next, the above-described butyl acetate solution as the composition for anti-reflective coatings is spin-coated on the semiconductor substrate.

Then, the semiconductor substrate is subjected to heat treatment at a temperature of 160° C. for 60 minutes. Thereby, an anti-reflective coating of a thickness of 100 nm is formed on the semiconductor substrate.

Thereafter, resist patterns are formed in the same manner as in the second embodiment.

As described above, in the method for manufacturing a semiconductor device according to the fourth embodiment, the anti-reflective coating was formed through the use of the composition for anti-reflective coatings comprising the polymer that contains fluorine (vinylidene fluoride polymer), and fluorocarbon-resin-based resist patterns were formed on the anti-reflective coating.

According to this manufacturing method, the same effect as in the second embodiment can be obtained.

Fifth Embodiment

A method for manufacturing a semiconductor device according to a fifth embodiment is the same as the method for manufacturing a semiconductor device according to the above-described second embodiment, except for a composition for anti-reflective coatings, and a heat treatment performed after the application of the composition for anti-reflective coatings.

The description below will be focused on these differences, and the description of items overlapping the items in the second embodiment will be omitted.

First, a composition for anti-reflective coatings according to a fifth embodiment will be described.

The composition for anti-reflective coatings according to the fifth embodiment is a mixed solution obtained by mixing and stirring a polymer that contains fluorine consisting of 10 g of a copolymer of fluoroethylene and vinyl ether, 2 g of an isocyanate-based hardening agent, and 40 g of xylene, and a solvent consisting of 120 g of methyl-iso-butyleketone.

Next, a method for manufacturing a semiconductor device using the above-described composition for anti-reflective coatings will be described.

First, the surface of a semiconductor substrate is treated with HMDS.

Next, the above-described mixed solution as the composition for anti-reflective coatings is spin-coated on the semiconductor substrate.

Then, the semiconductor substrate is subjected to heat treatment at a temperature of 180° C. for 2 minutes. Thereby, an anti-reflective coating of a thickness of 100 nm is formed on the semiconductor substrate.

Thereafter, resist patterns are formed in the same manner as in the second embodiment.

As described above, in the method for manufacturing a semiconductor device according to the fifth embodiment, the anti-reflective coating was formed through the use of the composition for anti-reflective coatings comprising the polymer that contains fluorine, and fluorocarbon-resin-based resist patterns were formed on the anti-reflective coating.

According to this manufacturing method, the same effect as in the second embodiment can be obtained.

The isocyanate-based hardening agent contained in the composition for anti-reflective coatings prevents the anti-reflective coating from reacting with the resist composition, when the resist composition is applied onto the anti-reflective coating. Therefore, the formation of a mixed layer at the interface between the anti-reflective coating and the resist film can be prevented, whereby the accuracy of exposure can be improved.

Furthermore, by adjusting the quantity of the isocyanate-based hardening agent added to the composition for anti-reflective coatings, the etching resistance of the anti-reflective coating can be controlled.

Sixth Embodiment

A method for manufacturing a semiconductor device according to a sixth embodiment is the same as the method for manufacturing a semiconductor device according to the above-described second embodiment, except for a composition for anti-reflective coatings, and a heat treatment performed after the application of the composition for anti-reflective coatings.

The description below will be focused on these differences, and the description of items overlapping the items in the second embodiment will be omitted.

First, a composition for anti-reflective coatings according to a sixth embodiment will be described.

The composition for anti-reflective coatings according to the sixth embodiment is a methanol solution of a solid content of 5%, comprising a polymer that contains fluorine consisting of a copolymer of perfluoro-(butenylvinylether) and hydroxyperfluoro-(4-vinyloxybutanoate), and a solvent consisting of methanol.

Next, a method for manufacturing a semiconductor device using the above-described composition for anti-reflective coatings will be described.

First, the surface of a semiconductor substrate is treated with HMDS.

Next, the above-described methanol solution as a composition for anti-reflective coatings is spin-coated on the semiconductor substrate.

Then, the semiconductor substrate is subjected to heat treatment at a temperature of 120° C. for 5 minutes. Thereby, an anti-reflective coating of a thickness of 100 nm is formed on the semiconductor substrate.

Thereafter, resist patterns are formed in the same manner as in the second embodiment.

As described above, in the method for manufacturing a semiconductor device according to the sixth embodiment, the anti-reflective coating was formed through the use of the composition for anti-reflective coatings comprising the polymer that contains fluorine, and fluorocarbon-resin-based resist patterns were formed on the anti-reflective coating.

According to this manufacturing method, the same effect as in the second embodiment can be obtained.

Furthermore, the dimensional variation, which was about ±50 nm when the composition for anti-reflective coatings according to Sixth Embodiment is not used, could be reduced to about ±20 nm. That is, the resist patterns could be formed in high accuracy.

This invention, when practiced illustratively in the manner described above, provides the following major effects:

According to the present invention, an anti-reflective coating that excels in adhesiveness to the photoresist can be provided, even if a fluorocarbon-resin-based photoresist is used. Also, a fluorocarbon-resin-based photoresist can be applied to the photolithography technique to form fine resist patterns.

Further, the present invention is not limited to these embodiments, but variations and modifications may be made without departing from the scope of the present invention.

The entire disclosure of Japanese Patent Application No. 2001-032918 filed on Feb. 8, 2001 containing specification, claims, drawings and summary are incorporated herein by reference in its entirety.

What is claimed is:

1. A composition for forming an anti-reflective coating on a semiconductor substrate, comprising:
a polymer containing fluorine; and
a solvent for dissolving said polymer.

2. The composition for forming an anti-reflective coating on a semiconductor substrate according to claim 1,
wherein said polymer contains at least one of polyimides, acrylic polymers, polymers having an alicyclic structure and fluorocarbon resins formed by homo-polymerizing or co-polymerizing fluorine-containing monomers.

3. The composition for forming an anti-reflective coating on a semiconductor substrate according to claim 2,
wherein the fluorine-containing monomers comprise at least one of fluoroolefines, fluorovinylether, vinylidene fluoride, vinyl fluoride, chlorofluoroolefines, and fluorovinylether having carboxylic groups or sulfonic groups.

4. The composition for forming an anti-reflective coating on a semiconductor substrate according to claim 1,
wherein said polymer contains 10% by weight or more fluorine atoms.

5. The composition for forming an anti-reflective coating on a semiconductor substrate according to claim 2,
wherein said polymer contains 10% by weight or more fluorine atoms.

6. The composition for forming an anti-reflective coating on a semiconductor substrate according to claim 3,
wherein said polymer contains 10% by weight or more fluorine atoms.

7. The composition for forming an anti-reflective coating on a semiconductor substrate according to claim 1,
wherein said polymer has a cross-linked structure.

8. The composition for forming an anti-reflective coating on a semiconductor substrate according to claim 2,
wherein said polymer has a cross-linked structure.

9. The composition for forming an anti-reflective coating on a semiconductor substrate according to claim 3,
wherein said polymer has a cross-linked structure.

10. The composition for forming an anti-reflective coating on a semiconductor substrate according to claim 4,
wherein said polymer has a cross-linked structure.

11. The composition for forming an anti-reflective coating on a semiconductor substrate according to claim 1,
wherein said solvent comprises at least one of alcohols, aromatic hydrocarbons, ketones, esters, chlorofluorocarbons, and super pure water.

12. The composition for forming an anti-reflective coating on a semiconductor substrate according to claim 2,
wherein said solvent comprises at least one of alcohols, aromatic hydrocarbons, ketones, esters, chlorofluorocarbons, and super pure water.

13. The composition for forming an anti-reflective coating on a semiconductor substrate according to claim 3,
wherein said solvent comprises at least one of alcohols, aromatic hydrocarbons, ketones, esters, chlorofluorocarbons, and super pure water.

14. The composition for forming an anti-reflective coating on a semiconductor substrate according to claim 4,
wherein said solvent comprises at least one of alcohols, aromatic hydrocarbons, ketones, esters, chlorofluorocarbons, and super pure water.

15. A method for manufacturing a semiconductor device, comprising:
an anti-reflective coating forming step for forming an anti-reflective coating by coating the composition for an anti-reflective coating according to claim 1 on a semiconductor substrate;
a resist film forming step for forming a resist film containing fluorine on the anti-reflective coating formed in said anti-reflective coating forming step; and
an exposure step for radiating exposure light onto the resist film formed in said resist film forming step.

16. The method for manufacturing a semiconductor device according to claim 15,
wherein said anti-reflective coating forming step comprises a heating step for heating the semiconductor substrate on which the anti-reflective coating is formed.

17. The method for manufacturing a semiconductor device according to claim 16,
wherein said heating step is performed at a temperature between 100° C. and 250° C. for 30 seconds to 60 minutes.

18. The method for manufacturing a semiconductor device according to claim 16,
wherein said heating step is performed in an oxygen atmosphere.

19. The method for manufacturing a semiconductor device according to claim 16,
wherein the thickness of the anti-reflective coating is made 150 nm or less in said heating step.

20. The method for manufacturing a semiconductor device according to claim 15,
wherein the wavelength of the exposure light radiated in said exposure step is 254 nm or less.
